(19) United States
(12) Patent Application Publication
(10) Pub. No.: US 2020/0096778 A1
(43) Pub. Date: Mar. 26, 2020

(54) OPTICAL REARRANGEMENT DEVICE, SYSTEM INCLUDING THE SAME AMD METHOD OF MANUFACTURING THE SAME

(71) Applicant: SAMSUNG ELECTRONICS CO., LTD., Suwon-Si (KR)

(72) Inventors: Ji-Young Chu, Gyeongju-Si (KR); Min-Hwan Seo, Hwaseong-Si (KR); Jung-Chul Lee, Hwaseong-Si (KR); Won-Don Joo, Namdong-Gu (KR)

(21) Appl. No.: 16/376,790

(22) Filed: Apr. 5, 2019

(30) Foreign Application Priority Data
Sep. 20, 2018 (KR) 10-2018-0112550

(51) Int. Cl. G02B 27/14; G02B 27/09; G02B 27/10; G02B 19/00

(52) U.S. Cl. CPC G02B 27/145; G02B 19/0019; G02B 27/106; G02B 27/0977

(57) ABSTRACT

An optical rearrangement device includes an optical block having a substantially hexahedral shape. The optical block includes a front face, a top face, a first side face, a bottom face, a second side face, and a back face. The top face is parallel with the bottom face. The optical block is arranged such that when an input beam is incident through the front face at a right angle thereto, the input beam is totally reflected at each of the top face, the bottom face, the first side face, and the second side face and an output beam is output through the front face or the back face at a right angle thereto.

### CROSS-REFERENCE TO RELATED APPLICATION

This U.S. Non-provisional application claims priority under 35 USC § 119 to Korean Patent Application No. 10-2018-0112550, filed on Sep. 20, 2018 in the Korean intellectual Property Office (KIPO), the disclosure of which is incorporated by reference in its entirety herein.

### TECHNICAL FIELD

The present disclosure relates to an optical system and more particularly, to an optical rearrangement device, a system including an optical rearrangement device and a method of manufacturing an optical rearrangement device.

### DISCUSSION OF THE RELATED ART

Various optical devices are used to alter the characteristics of light traveling therethrough. For example, optical devices may be used to change an angle and/or a distribution of light, such as a laser beam. When a line-shaped beam has a different distribution of angles in a vertical direction and a horizontal direction, it may be desired to reverse the angle distributions or to rotate the angle distributions by 90 degrees while maintaining the entire shape of the beam. For example, if a beam is elongated using a lens to form a line beam, the angle distribution in a long axis direction is relatively small and the angle distribution in a short axis direction is relatively large, which restricts forming a thin line beam. In this case, it is effective to reverse the angle distribution in the vertical direction and the angle distribution in the horizontal direction. In addition, when generating a laser beam of high power using a laser diode array, reversing of the angle distributions may be desired to focus the beams.

### SUMMARY

An optical rearrangement device includes an optical block having a substantially hexahedral shape. The optical block includes a front face, a top face, a first side face, a bottom face, a second side face, and a back face. The top face is parallel with the bottom face. The optical block is arranged such that when an input beam is incident through the front face at a right angle thereto, the input beam is totally reflected at each of the top face, the bottom face, the first side face, and the second side face and an output beam is output through the front face or the back face at a right angle thereto.

An optical rearrange tent device includes an optical block having a hexahedral shape. The optical block includes a front face, a top face, a first side face, a bottom face, a second side face, and a back face. The top face is parallel with the bottom face. The optical block is arranged such that a face angle between the front face and the bottom face is 45 degrees or 135 degrees, a face angle between the back face and the bottom face is 45 degrees or 135 degrees, a face angle between the first side face and the bottom face is 60 degrees or 120 degrees, a face angle between the second side face and the bottom face is 60 degrees or 120 degrees, a face angle between the front face and the first side face is 90 degrees, and a face angle between the from face and the second side face is 45 degrees or 135 degrees.

An optical rearrangement system includes a plurality of optical rearrangement devices, each of which includes an optical block having a substantially hexahedral shape. The optical block includes a front face, a top face, a first side face, a bottom face, a second side face, and a back face. The top face is parallel with the bottom face. The optical block is arranged such that, when an input beam is incident through the front face at a right angle thereto, the input beam is totally reflected at each of the top face, the bottom face, the first side face, and the second side face and an output beam is output through the front face or the back face at a right angle thereto.

A beam forming system includes an optical rearrangement device having an optical block with a substantially hexahedral shape. The optical block includes a front face, a top face, a first side face, a bottom face, a second side face, and a back face. The optical block is arranged such that, when an input beam is incident through the front face at a right angle thereto, the input beam is totally reflected at each of the top face, the bottom face, the first side face, and the second side face and an output beam is output through the front face or the back face at a right angle thereto. A focusing lens unit is configured to focus the output beam to generate a final beam of a line shape or a spot shape.

A method of manufacturing an optical rearrangement device includes rotating an optical block having a top face and a bottom face perpendicular to Y axis by 45 degrees or −45 degrees about an X axis to dispose the optical block in an inclined state. A first side face of the optical rearrangement device is formed by cutting the optical block in the inclined state in parallel with a plane corresponding to a YZ plane that is rotated by 45 degrees or −45 degrees about a Z axis. A second side face of the optical rearrangement device is formed by cutting the optical block in the inclined state in parallel with a plane corresponding to the YZ plane that is rotated by 45 degrees or −45 degrees about a Y axis. A front face of the optical rearrangement device is formed by cutting the optical block in the inclined state in parallel with an XY plane or an XZ plane.

### BRIEF DESCRIPTION OF THE DRAWINGS

A more complete appreciation of the present disclosure and many of the attendant aspects thereof will be readily obtained as the same becomes more clearly understood from the following detailed description taken in conjunction with the accompanying drawings, wherein:

FIG. 1 is a flow chart illustrating a method of manufacturing an optical rearrangement device according to exemplary embodiments of the present disclosure,

FIGS. 2A and 2B are diagrams illustrating a rotation angle and a face angle used in accordance with exemplary embodiments of the present disclosure;

FIG. 3 is a diagram illustrating an optical rearrangement device according to exemplary embodiments of the present disclosure;

FIGS. 4 through 9 are diagrams illustrating a method of manufacturing an optical rearrangement device according to exemplary embodiments of the present disclosure;

FIGS. 10 and 11 are diagrams illustrating propagation by an optical rearrangement device according to exemplary embodiments of the present disclosure;

FIGS. 12 through 15B are diagrams illustrating division and reverse of angle distributions by an optical rearrangement device according to exemplary embodiments of the present disclosure;

FIGS. 16A and 16B are diagrams illustrating a method of manufacturing an optical rearrangement device according to exemplary embodiments of the present disclosure;

FIGS. 17 and 18 are diagrams illustrating optical rearrangement devices according to exemplary embodiments of the present disclosure;

FIGS. 19 through 22 are diagrams illustrating a method of manufacturing an optical rearrangement device according to exemplary embodiments of the present disclosure;

FIG. 23 is a diagram illustrating an optical rearrangement device according to exemplary embodiments of the present disclosure;

FIGS. 24A, 24B and 24C are diagrams illustrating an optical rearrangement system according to exemplary embodiments of the present disclosure;

FIG. 25 is a diagram illustrating a beam forming system according to exemplary embodiments of the present disclosure; and

FIGS. 26 through 28 are diagrams illustrating a beam forming processes utilized by the beam forming system of FIG. 25, in accordance with exemplary embodiments of the present disclosure.

### DETAILED DESCRIPTION OF THE EMBODIMENTS

Various exemplary embodiments of the present disclosure will be described more fully hereinafter with reference to the accompanying drawings. Like numerals may refer to like elements throughout the disclosure and the drawings. To the extent that repeated descriptions of various features and structures are omitted, it may be assumed that these features and structures are at least similar to corresponding elements that have been described elsewhere in the specification.

Hereinafter, exemplary embodiments of the present disclosure are described using an orthogonal set of axes, including, for example, an X axis, a V axis, and a Z axis. According to this coordinate set, an XY plane is perpendicular to the Z axis, an YZ plane is perpendicular to the X axis, and a ZX plane is perpendicular to the Y axis. The X axis, the Y axis and the Z axis are used to describe three orthogonal directions, and the present invention is not limited to particular fixed directions. Unless described to the contrary, the Z direction is perpendicular to an incident plane through which an input beam is incident and an output plane through which an output beam is output.

In this disclosure, “front face”, “top face”, “first side face”, “bottom face”, “second side face” and “back face” are used not to represent particular fixed faces of a hexahedron but to represent relative positions of the hexahedron. The front face and the back face are two opposite faces, the top face and the bottom face are two opposite faces and the first side face and the second side face are two opposite faces.

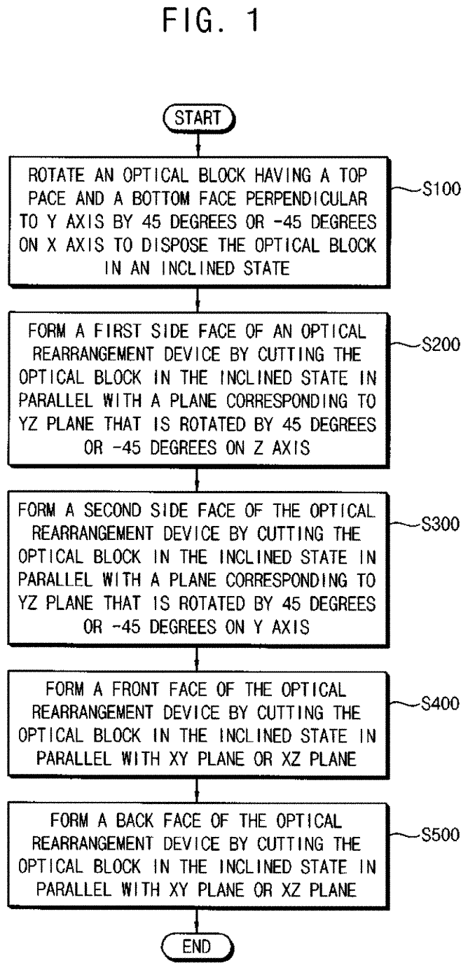

FIG. 1 is a flow chart illustrating a method of manufacturing an optical rearrangement device according to exemplary embodiments of the present disclosure.

Referring to FIG 1, an optical block having a top face and a bottom face perpendicular to the Y axis may be rotated by 45 degrees or −45 degrees about an X axis to dispose the optical block in an inclined state (S100). The optical block may have a hexahedral shape formed of a same material as optical devices such as a lens, a prism, etc. The top face and the bottom face of the optical block correspond to those of the optical rearrangement device. Accordingly, the optical rearrangement device, according to exemplary embodiments of the present disclosure, has the top face and the back face that are parallel with each other.

A first side face of the optical rearrangement device may be formed by cutting the optical block in the inclined state in parallel with a plane corresponding to the YZ plane that is rotated by 45 degrees or −45 degrees about the Z axis (S200).

A second side face of the optical rearrangement device may be formed by cutting the optical block in the inclined state in parallel with a plane corresponding to the YZ plane that is rotated by 45 degrees or −45 degrees about the Y axis (S300).

In some exemplary embodiments of the present disclosure, the first side face may correspond to a right side face and the second side face may correspond to a left side face. Alternatively, the first side face may correspond to a left side face and the second side face may correspond to a right side face.

A front face of the optical rearrangement device may be formed by cutting the optical block in the inclined state in parallel with the XY plane or the XZ plane (S400).

A back face of the optical rearrangement device may be formed by cutting the optical block in the inclined state in parallel with the XY plane or the XZ plane (S500).

Forming the first side face (S200), forming the second side face (S300), forming the front face (S400) and forming the back face (S500) may be performed either in the stated order or in any other order. The optical rearrangement device may be provided regardless of the cutting order if the inclined state is maintained during the cutting processes.

In some exemplary embodiments of the present disclosure, the front face may correspond to both of an incident plane, through which an input beam is incident, and an output plane, through which an output beam is output. In this case, forming the back face (S500) may be omitted. In some exemplary embodiments of the present disclosure, the front face may correspond to the incident plane and the back face may correspond to the output plane.

When it is desired to divide a beam into a plurality of portions to rotate the angle distributions of the respective portions of the beam while maintaining the entire shape of the beam, the conventional schemes divide the beam using a prism array or a cylindrical lens array and rotate each of the divided portions of the beam using respective optical devices. In this case, it is very difficult to process and arrange the optical devices properly.

In some conventional schemes, a beam is incident obliquely between two parallel mirrors and output portions of the beam sequentially depending on the number of reflections by the two mirrors. Even though such system is relatively simple, there are problems such that the loss rate of the portions are different and defects occur in reflection coating of the mirrors when a high-power beam is used.

In the optical rearrangement device manufactured by the method of FIG. 1, the front face, the top face, the first side face, the bottom face, the second side face and the back face may form face angles such that, when an input beam is incident through the front face at a right angle, the input beam is totally reflected at the top face, the bottom face, the first side face and the second side face and an output beam is output through the front face or the back face at a right angle. The beam propagating in the optical rearrangement device may be totally reflected with an incidence angle of 45 degrees and a reflection angle of 45 degrees.

As such, the optical rearrangement device, according to exemplary embodiments of the present disclosure, may reduce loss of light of a beam using only vertical incidence, vertical penetration and total reflection.

In addition, the optical rearrangement device manufactured by the method of FIG. 1 may divide the input beam propagating in a Z direction into a plurality of portions, reverse a first axis in an X direction and a second axis in a Y direction with respect to each of the plurality of portions and provide the output beam including a plurality of sliced beams that are arranged in the X direction. As such, the optical rearrangement device, according to exemplary embodiments of the present disclosure, may efficiently implement the division of the input beam and the reversing of the angle distributions using one optical block.

Further, the optical rearrangement device, according to exemplary embodiments of the present disclosure, may be manufactured easily through cutting of one optical block and arranged conveniently with other optical devices when forming an optical system such as a beam forming system.

For convenience of illustration and description, exemplary embodiments of the present disclosure are described as using a rotation angle of 45 degrees, but the present inventive concept is not limited thereto. The optical rearrangement device, according to exemplary embodiments of the present disclosure, may be implemented by cutting the optical block using a proper combination of acute rotation angles other than 45 degrees.

In addition, the optical rearrangement device, according to exemplary embodiments of the present disclosure, may be manufactured by disposing the optical block in a parallel state that is perpendicular to the Y axis and performing the cutting processes by rotating the above-described cutting planes by −45 degrees about the X axis.

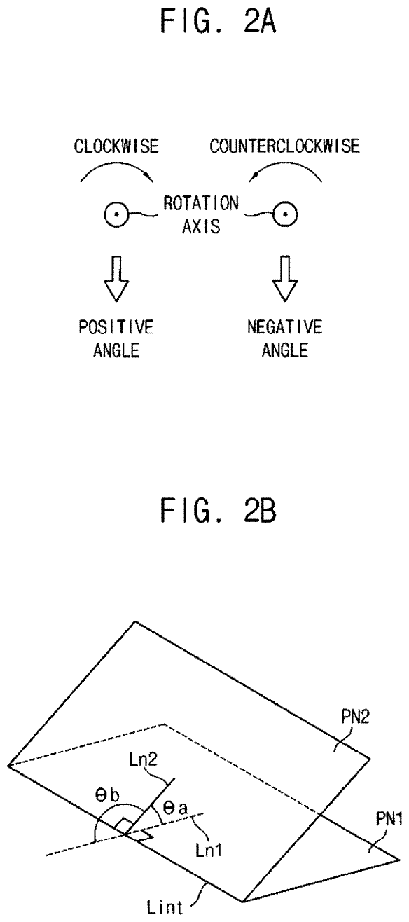

FIGS. 2A and 2B are diagrams illustrating a rotation angle and a face angle used in accordance with exemplary embodiments of the present disclosure.

Referring to FIG. 2A, when viewing the rotation axis, the clockwise rotation angle may be defined as the positive direction and the counterclockwise rotation angle may be defined as the negative direction. The definition of the rotation angle is provided for convenience of illustration and description, and the optical rearrangement device may be provided even if the rotation angle is defined reversely.

Referring to FIG. 2B, a face angle between a first plane PN1 and a second plane PN2 may be defined as two angles θa and θb between two normal lines Ln1 and Ln2, which are included in the planes PN1 and PN2 and perpendicular to a line Lint of intersection of the planes PN1 and PN2, respectively. Unless otherwise provided, the face angle in this disclosure may represent the one angle included in the optical rearrangement device among the two angles θa and θb.

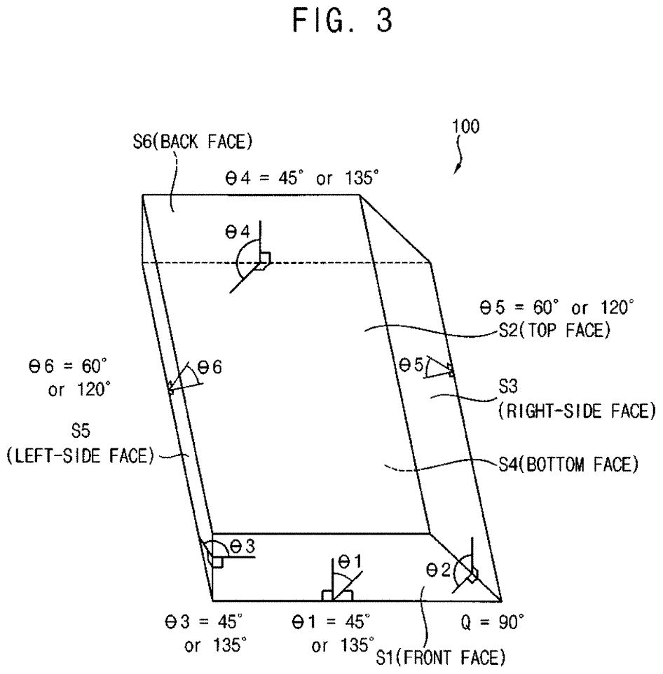

FIG. 3 is a diagram illustrating an optical rearrangement device according to exemplary embodiments of the present disclosure.

Referring to FIG. 3, an optical rearrangement device 100 may include an optical block of a hexahedral shape having a front face S1, a top face S2, a first (right) side face S3, a bottom face S4, a second (left) side face S5 and a back face S6. The top face S2 and the bottom face S4 are parallel with each other. For convenience of illustration and description, it is considered that the first side face S3 corresponds to a right side face and the second side face S5 corresponds to a left side face. However, as described above, the same descriptions may be applied in a case where the first side face S3 corresponds to a left side face and the second side face S5 corresponds to a right side face.

In some exemplary embodiments of the present disclosure, the optical rearrangement device 100 may be provided by the method of FIG. 1, and the top face S2 and the bottom face S4 may each be shaped as parallelograms or trapeziums. FIG. 3 illustrates a non-limiting example of the parallelogram case.

The front face S1, the top face S2, the first side face S3, the bottom face S4, the second side face S5 and the back face S6 may form face angles such that, when an input beam is incident through the front face S1 at a right angle with respect thereto (e.g. tangentially incident), the input beam may be totally reflected at the top face S2, the bottom face S4, the first side face S3 and the second side face S5 and an output beam may be output through the front face S1 or the back face S6 at a right angle with respect thereto. Because the top face S2 and the bottom face S4 are parallel to each other, the face angle between the top face S2 and one face is a supplementary angle of the face angle between the bottom face S4 and the one face. The beam propagating in the optical rearrangement device 100 may be totally reflected with an incidence angle of 45 degrees and a reflection angle of 45 degrees.

FIG. 3 Illustrates a face angle θ1 between the front face S1 and the bottom face S4, a face angle θ2 between the front face S1 and the first side face S3, a face angle θ3 between the front face S1 and the second side face S5, a face angle θ4 between the back face S6 and the bottom face S4, a face angle θ5 between the first side face S3 and the bottom face S4 and a face angle θ6 between the second side face S5 and the bottom face S4. For perpendicular output in a case where the output beam is output through the back face S6, the back face S6 may be parallel with or perpendicular to the front face S1. When the six face angles θ1 through θ6 are determined, the rest of the face angles may be determined definitively.

As illustrated in FIG. 3, according to the cutting planes, the face angle θ1 between the bottom face S4 may be 45 degrees or 135 degrees, the face angle θ4 between the back face S6 and the bottom face S4 may be 45 degrees or 135 degrees, the face angle θ5 between the first side face S3 and the bottom face S4 may be 60 degrees or 120 degrees, and the face angle θ6 between the second side face S5 and the bottom face S4 may be 60 degrees or 120 degrees. In addition, the face angle θ2 between the front face S1 and the first side face S3 may be 90 degrees, and the thee angle θ3 between the front face S1 and the second side face S5 may be 45 degrees or 135 degrees, according to the cutting planes.

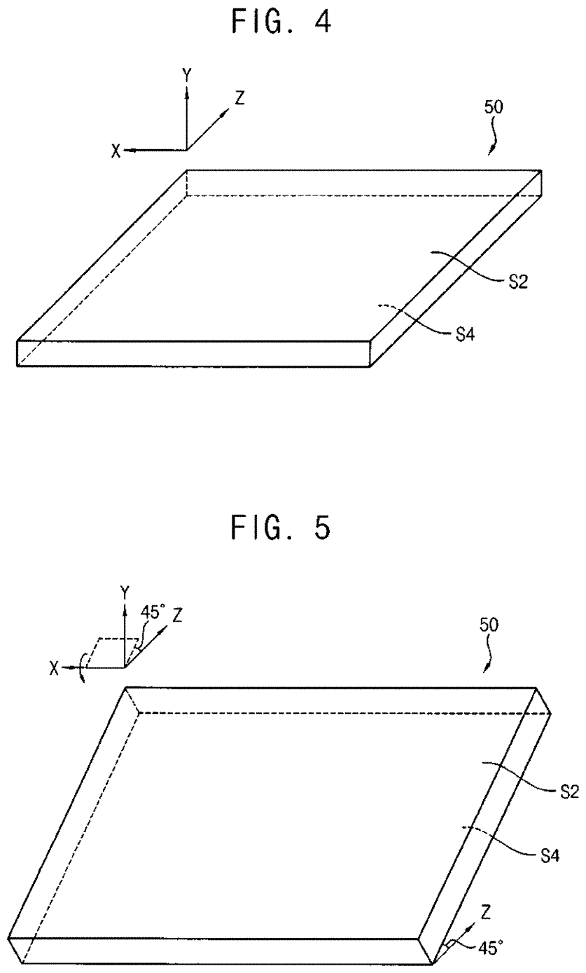

FIGS. 4 through 9 are diagrams illustrating a method of manufacturing an optical rearrangement device according to exemplary embodiments of the present disclosure.

Referring to FIG. 4, an optical block 50 is provided for manufacturing an optical rearrangement device. The optical block 50 may have a hexahedral shape formed of a same material that optical devices such as a lens, a prism, etc. are generally formed from. The top face S2 and the bottom face S4 of the optical block 50 are parallel and perpendicular to the Y axis. The top face S2 and the bottom face S4 of the optical block 50 may be used as the top face S2 and the bottom face S4 of the optical rearrangement device, respectively, after the manufacturing process is finished.

Referring to FIG. 5, the optical block 50 may be rotated by 45 degrees about the X axis to dispose the optical block 50 in an inclined state. The case of the inclined state corresponding to the rotation angle of 45 degrees are described with reference to FIGS. 5 through 9, but the present inventive concept not limited thereto.

In some exemplary embodiments of the present disclosure, the optical rearrangement device may be provided by disposing the optical block 50 in an inclined state corresponding to the rot angle of −45 degrees and performing the above-described cutting processes.

In some exemplary embodiments of the present disclosure, the optical rearrangement device, according to exemplary embodiments of the present disclosure, may be provided by disposing the optical block in a parallel state perpendicular to Y the axis and performing the cutting processes by rotating the above-described cutting planes by −45 degrees about the X axis.

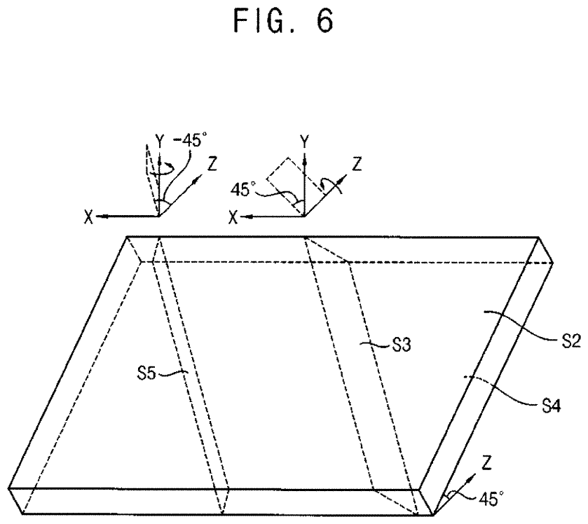

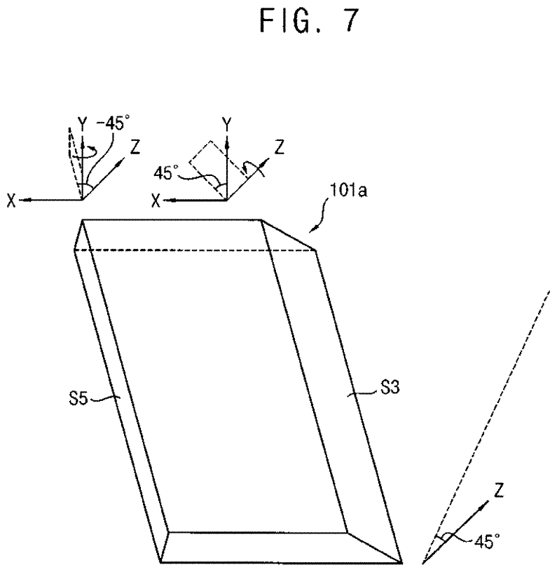

Referring to FIG. 6, the first side face S3 of the optical rearrangement device may be formed by cutting the optical block 50 in the inclined state in parallel with a plane corresponding to the YZ plane that is rotated by 45 degrees about the Z axis, and the second side face S5 of the optical rearrangement device may be formed by cutting the optical block in the inclined state in parallel with a plane corresponding to the YZ plane that is rotated by −45 degrees about the Y axis. FIG. 7 illustrates an optical block 101a after the cutting processes of FIG. 6 are performed.

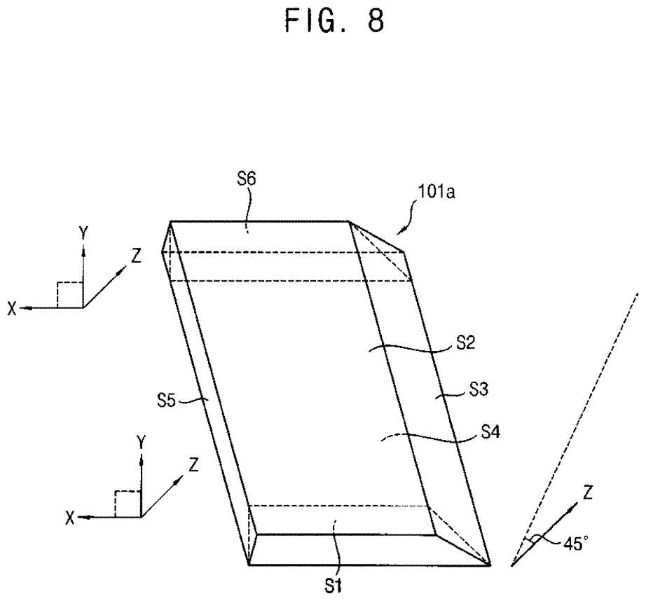

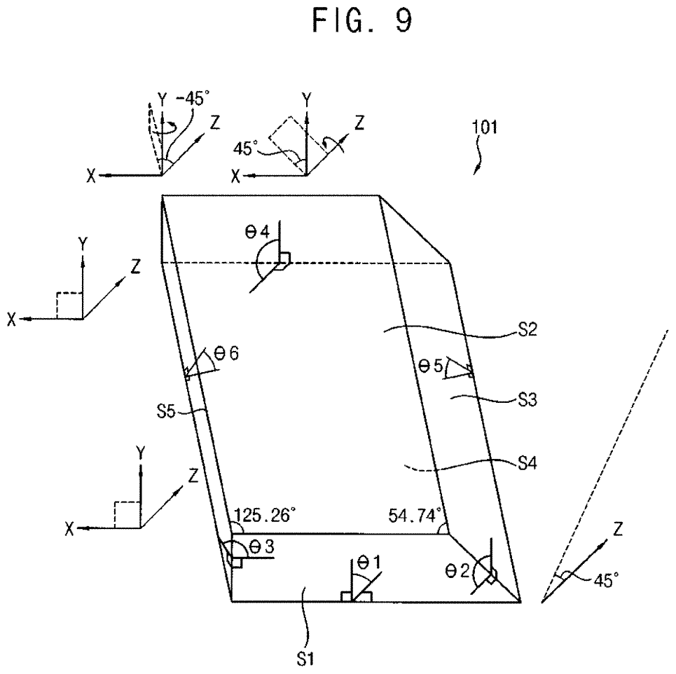

Referring to FIG. 8, the front face S1 of the optical rearrangement device may be formed by cutting the optical block 101a in the inclined state in parallel with the XY plane, and the back face S6 of the optical rearrangement device may be formed by cutting the optical block 101a in the inclined state in parallel with the XY plane. FIG. 9 illustrates a final optical rearrangement device 101 after the cutting processes of FIGS. 6 and 8 are performed.

Hereinafter, the face angles of the optical rearrangement device 101 are described with reference to FIG. 9.

A normal vector V1 of the front face S1, a normal vector V2 of the top face S2, a normal vector V3 of the first side face S3, a normal vector V4 of the bottom face S4, a normal vector V5 of the second side face S5 and a normal vector V6 of the back face S6 may be obtained by Expression 1.

V1=(0, 0, 1) or (0, 0, −1)

V2=(0, 1, −1) or (0, −1, 1)

V3=(1, −1, 0) or (−1, 1, 0)

V4=(0, −1, 1) or (0, 1, −1)

V5=(1, 0, −1) or (−1, 0, 1)

V6=(0, 0, −1) or (0, 0, 1) Expression 1

A face angle between two planes lay be obtained using an inner product according to Expression 2.

Vi·Vj=|Vi||Vj|cos θ Expression 2

In a Expression 2, Vi indicates a normal vector of a face Si, Vj indicates a normal vector of a face Sj and θ indicates a face angle or a supplementary angle between the two faces Si and Sj. As described above with reference to FIG 2B, unless otherwise provided, the face angle θ may correspond to the one angle included in the optical rearrangement device among the two angles θa and θb.

Obtaining the face angles using Expression 1 and Expression 2 with respect to the optical rearrangement device 101 of FIG. 9, the face angle θ1 between the front face S1 and the bottom face S4 is 45 degrees, the face angle θ4 between the back face S6 and the bottom face S4 is 135 degrees, the face angle θ5 between the first side face S3 and the bottom face S4 is 60 degrees, the face angle θ6 between the second side face S5 and the bottom face S4 is 60 degrees, the face angle θ2 between the front face S1 and the first side face S3 is 90 degrees, and the face angle θ3 between the from face S1 and the second side face S5 is 135 degrees.

Because the top face S2 and the bottom face S4 are parallel to each other and the back face S6 is parallel with or perpendicular to the front face S1 for perpendicular output through the back face S6 when at least the six face angles θ1 through θ6 are determined, the rest of the face angles may be determined definitively.

The optical rearrangement device 101 of FIG. 9 corresponds to a case in which the top face S2 and the bottom face S4 are parallelograms. The angles between the edges of the top face S2 and the bottom face S4 are about 54.74 degrees and about 125.26 degrees corresponding to the supplementary angle of 54.74 degrees.

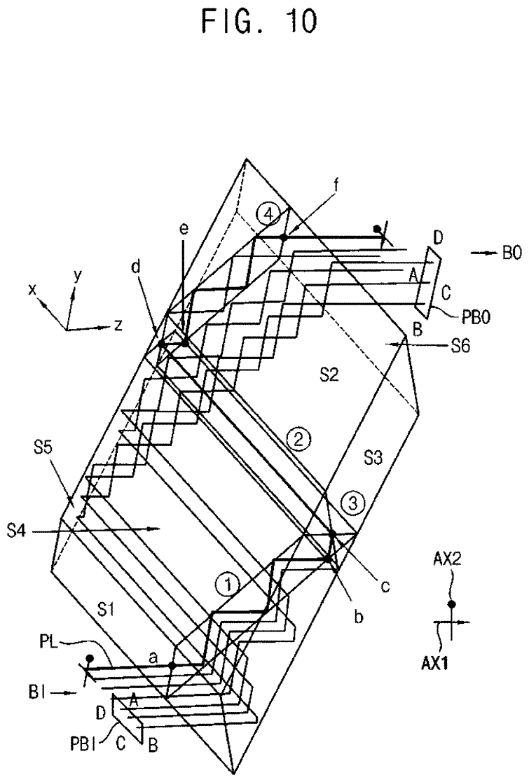

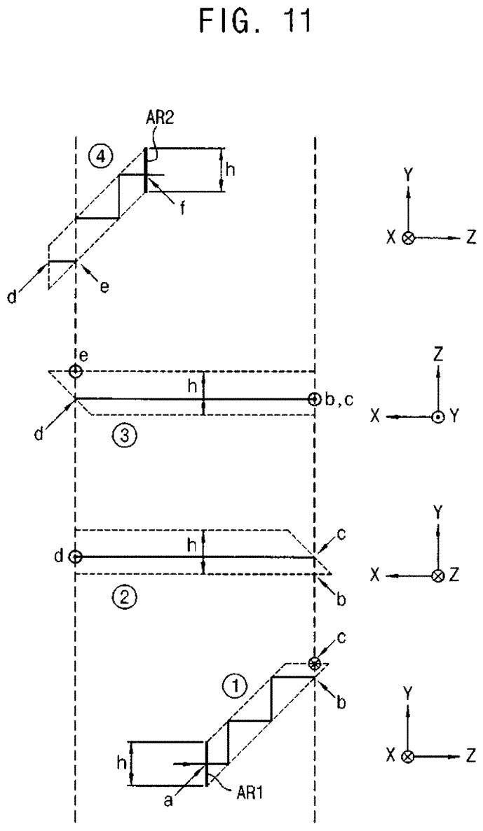

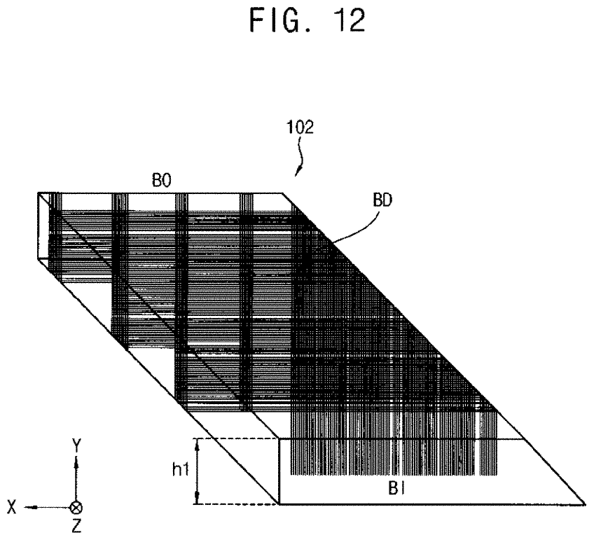

FIGS. 10 and 11 are diagrams illustrating propagation by an optical rearrangement device according to exemplary embodiments of the present disclosure.

Referring to FIG. 10, when an input beam BI is incident through the front face S1 at a right angle, the input beam BI may be totally reflected at the top face S2, the bottom face S4, the first side face S3 and the second side face S5 and an output beam BO may be output through the front face S1. The beam totally reflected inside the optical rearrangement device 101 may have an incidence angle of 45 degrees and a reflection angle of 45 degrees with respect to each total reflection plane, and thus the incident beam and the reflected beam at each total reflection plane may form angles of 90 degrees.

The optical rearrangement device 101 may divide the input beam BI propagating in the Z direction into a plurality of portions, reverse a first axis AX1 in the X direction and a second axis AX2 in the Y direction with respect to each of the plurality of portions and provide the output beam BO including a plurality of sliced beams that are arranged in the X direction.

FIG. 10 illustrates one portion PBI of the input beam BI and one corresponding sliced beam PBO of the output beam BO. For each portion PBI, the first axis AX1 is parallel with the X axis and the second axis AX2 is parallel with the Y axis. In contrast, for each sliced beam PBO, the first axis AX1 is parallel with the Y axis and the second axis AX2 is parallel with the X axis.

When viewing in the Z direction, the edges of each portion PBI of the input beam BI is in the order of ABCD, but the edges of each sliced beam PBO of the output beam BO is in the order of DCBA. As such, the optical rearrangement device 101 may reverse or rotate by 90 degrees the angle distributions with respect to each portion PBI of the input beam BI to provide each sliced beam PBO of the output beam BO.

FIG. 11 illustrates optical paths of cross-sectional planes \textcircled{1}, \textcircled{2}, \textcircled{3} and \textcircled{4} on which light PL in the input beam BI propagates inside the optical rearrangement device 101.

Referring to the cross-sectional plane \textcircled{1}, the light PL incident at a right angle on point “a” on the front face S1 is incident at an angle of 45 degrees on the bottom face S4 and the top face S2, totally reflected alternately in the Z direction and the Y direction by the bottom face S4 and the top face S2 and finally reflected at point “b” on the bottom face S4.

After that, as shown in the cross-sectional plane \textcircled{2}, the light is incident at an angle of 45 degrees on point “c” on the first side face S3, totally reflected there and then propagates in parallel with the X axis.

After that, as shown in the cross-sectional plane \textcircled{3}, the light is incident at an angle of 45 degrees on point “d” on the second side face S5, totally reflected there, propagates in parallel with the X axis and then is incident at an angle of 45 degrees on point “e” on bottom face S4.

After that, as shown in the cross-sectional plane \textcircled{4}, the light is incident at an angle of 45 degrees at the bottom face S4 and the top face S2, totally reflected by the bottom face S4 and the top face S2 alternately, and finally output at a right angle through point “f” on the back face S6.

The light propagating inside the optical rearrangement device 101 may be totally reflected with the incidence angle of 45 degrees and the reflection angle of 45 degrees at each total reflection plane, and thus the loss of light by reflections and the coating problem may be alleviated.

An anti-reflection coating layer AR1 may be formed on the front face S1 to reduce the loss of light during incidence of the input beam BI. In addition, an anti-reflection coating layer AR2 may be formed on the back face S2 to reduce the loss of light during output of the output beam BO.

FIGS. 12 through 15B are diagrams illustrating division and reverse of angle distributions by an optical rearrangement device according to exemplary embodiments of the present disclosure.

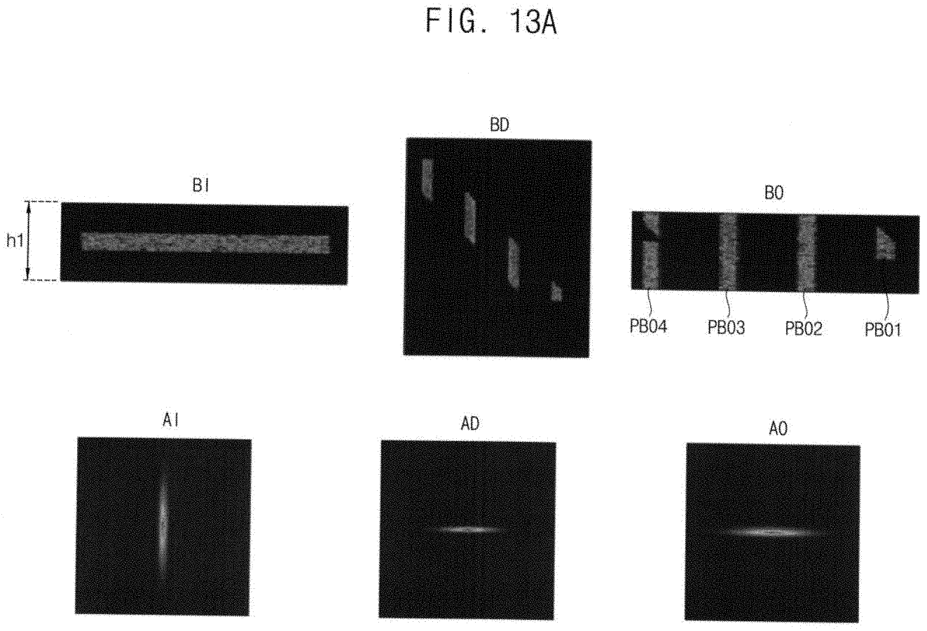

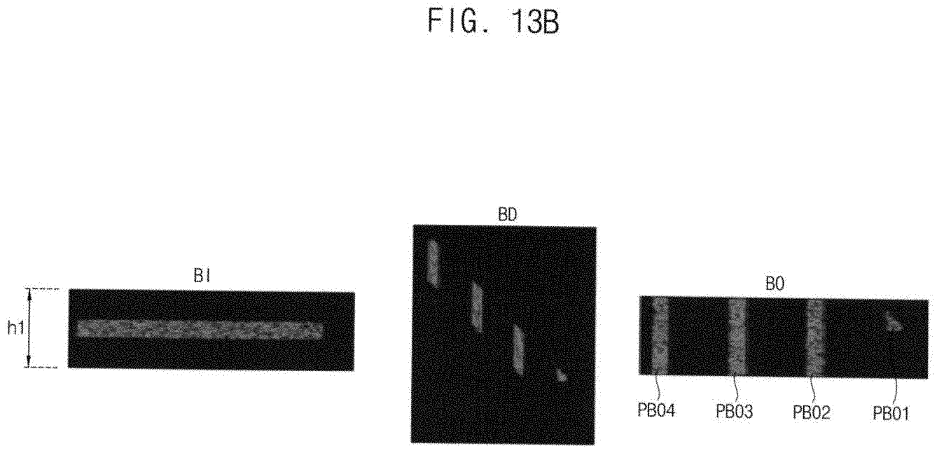

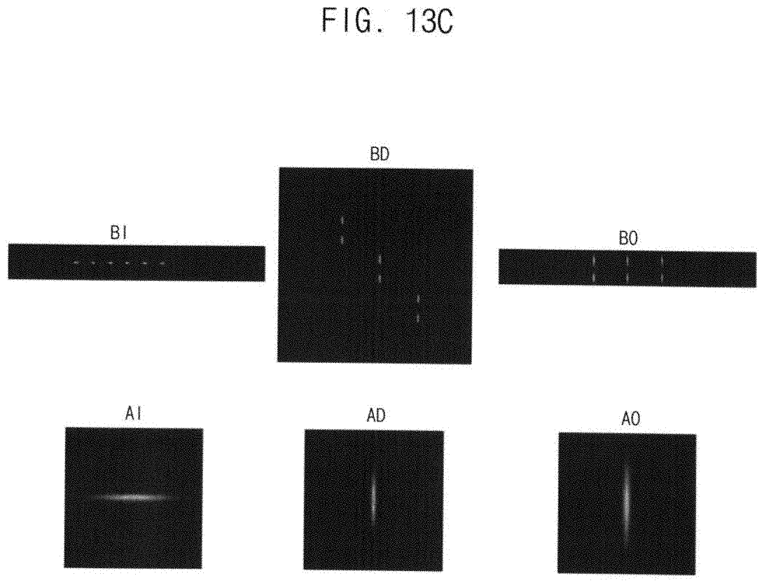

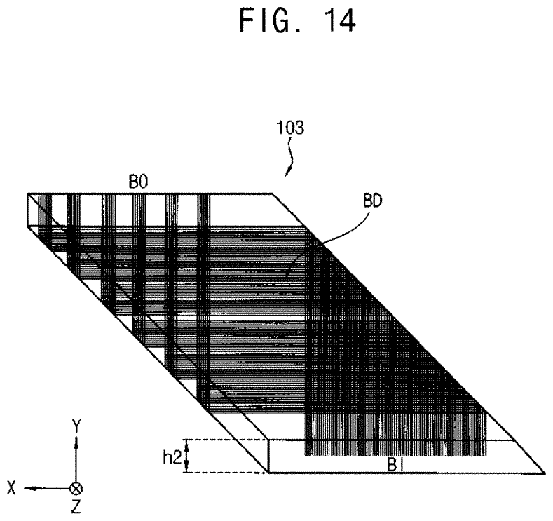

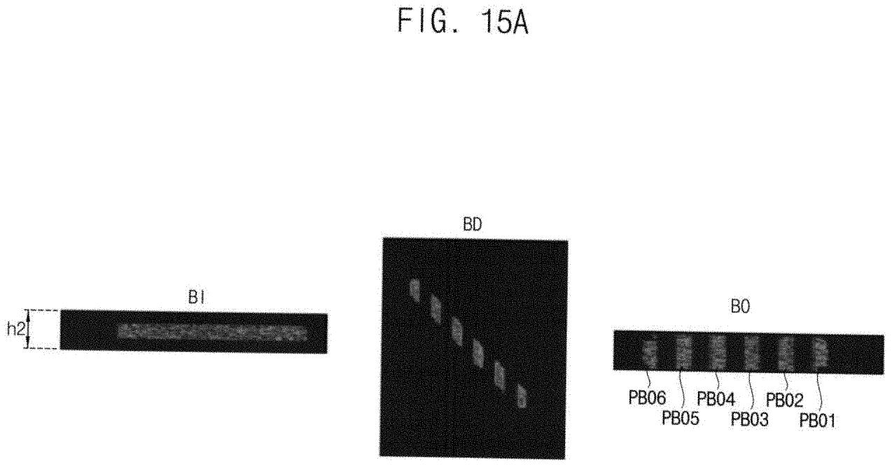

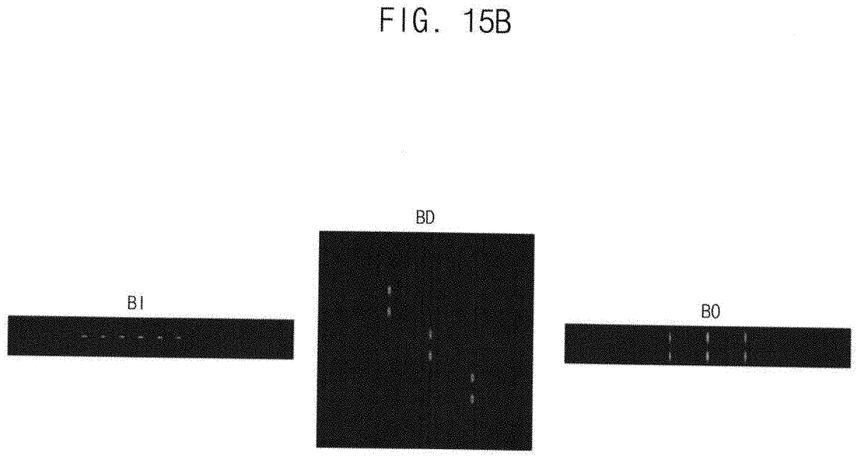

FIGS. 13A, 13B and 13C illustrate propagation by an optical rearrangement device 102 of FIG. 12, and FIGS. 15A and 15B illustrate propagation by an optical rearrangement device 103 of FIG. 14.

In FIGS. 12 through 15B, BI indicates an input beam, BD indicates divided beams of the input beam BI on a diagonal plane parallel with the YX plane, BO indicates an output beam, and PBOi (where i is a positive integer) indicates a sliced beam of the output beam BO. In FIGS. 13A and 13C, AI, AD and AO indicate angle distributions of the input beam BI, the divided beam BD and the output beam BO, respectively. FIGS. 13A, 13B and 15A correspond to cases that the input beam BI is elongated in the X direction, for example, by a beam expander, and FIGS. 13C and 15B correspond to cases in which the input beam BI is a set of lights output from a plurality of laser diodes and arranged in the X direction. Here, h1 indicates a thickness of the incidence plane of the optical rearrangement device 102 of FIGS. 12 and h2 indicates a thickness of the incidence plane of the optical rearrangement device 103 of FIG. 14. When the incidence plane forms an angle of 45 degrees with the bottom face, the thickness of the incidence plane is sqrt(2) (the square root of 2) times the thickness of the optical rearrangement device.

When the input beam BI of a line shape is incident on the front face of the optical rearrangement device 102 of FIG. 12, the shapes of the beam at the front face, the diagonal plane and the back face are as shown in FIGS. 13A and 13B. The long axis of the line beam is maintained but the beam is divided, the divide beams are rotated by 90 degrees and thus the sliced beams PBOi of the output beam BO may be provided. The line beam is divided sequentially into portions of the parallelogram shape depending on positions of total reflection on the right side face, totally reflected again by the left side face and output as the sliced beams PBOi of quadrangle shapes. The end portion of the output beam BO may be varied depending an the position of the input beam BI as illustrated in FIGS. 13A and 13B, and thus the incidence position of the input beam BI may be determined based on the thickness h1 of the incidence plane of the optical rearrangement device 102. The thickness h2 of the incidence plane of the optical rearrangement device 103 of FIG. 14 is half of the thickness h1 of the incidence plane of the optical rearrangement device 102 of FIG. 12. In comparison with the sliced beams PBO1 through PBO4 of the FIGS. 13A and 13B, the sliced beams PBO1 through PBO6 of FIG. 15A has the greater number, the lesser length in the Y direction and the lesser interval between the adjacent sliced beams. As such, the number and the width of the plurality of sliced beams may be adjusted based on a thickness between the top face and the bottom face.

Referring to FIGS. 13C and 15B, when the input beam BI is a plurality of lights arranged in a line shape that may be provided from, for example, a plurality of laser diodes, the light arrangement of the output beam. BO may be adjusted based on the thickness of the incidence plane, for example, the front face.

FIGS. 13A and 13C also illustrate the corresponding angle distributions AI, AD and AO. Here, the angle distributions may be used in the same meaning as M square, that is, M².

In the field of optics, beam parameter product (BPP) indicates a product of a divergence angle of a laser beam and a radius at the most narrow position of the laser beam. Here, M² may represent a ratio of BPP of a real beam to BPP of an ideal Gaussian beam with respect to the same wavelength. Here, M² is a wavelength-independent value representing beam quality.

As illustrated in FIGS. 13A and 13C, the optical rearrangement device, according to exemplary embodiments of the present disclosure, may implement, efficiently and simultaneously, the reversing of the angle distributions in the X direction and the Y direction in addition to the division of the input beam.

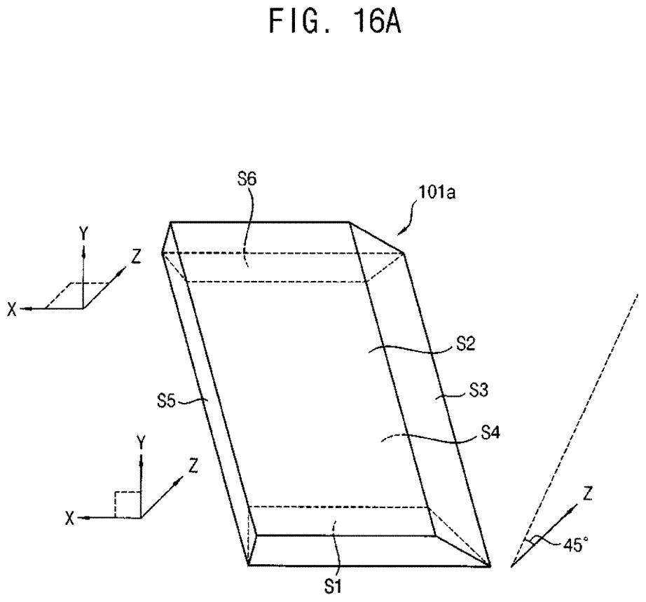

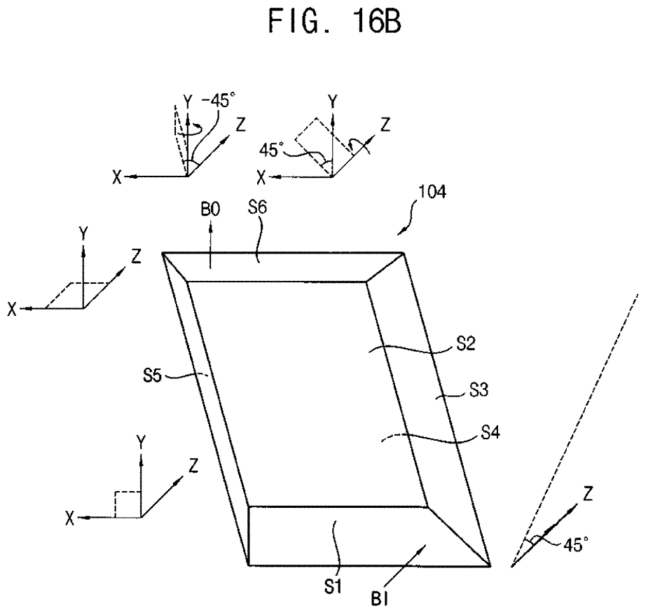

FIGS. 16A and 16B are diagrams illustrating a method of manufacturing an optical rearrangement device according to exemplary embodiments of the present disclosure.

As described with reference to FIGS. 4, 5 and 6, the optical block 50 may be rotated by 45 degrees about the X axis to dispose the optical block 50 in the inclined state, the first side face S3 of the optical rearrangement device may be formed by cutting the optical block 50 in the inclined state in parallel with a plane corresponding to the YZ plane that is rotated by 45 degrees about the Z axis, and the second side face S5 of the optical rearrangement device may be formed by cutting the optical block in the inclined state in parallel with a plane corresponding to the YZ plane that is rotated by −45 degrees about the Y axis. FIG. 16A illustrates an optical block 101a after the cutting processes of FIG. 6 are performed.

Referring to FIG. 16A, the front face S1 of the optical rearrangement device may be formed by cutting the optical block 101a in the inclined state in parallel with the XY plate, and the back face S6 of the optical rearrangement device may be formed by cutting the optical block 101a in the inclined state in parallel with the XZ plane. FIG. 16B illustrates a final optical rearrangement device 104 after the cutting processes of FIGS. 6 and 16A are performed.

The face angles of the optical rearrangement device 104 may be obtained using Expression 1 and Expression 2 substantially as described above with reference to FIG. 9 with replacement of the normal vector V6 in Expression 1 with (0, 1, 0) or (0, −1, 0) in the case of the optical rearrangement device 104 of FIG. 16B.

Obtaining the face angles using the inner product of the normal vectors with respect to the optical rearrangement device 104 of FIG. 16B, the face angle θ1 between the front face S1 and the bottom face S4 is 45 degrees, the face angle θ4 between the back face S6 and the bottom face S4 is 45 degrees, the face angle θ5 between the first side face S3 and the bottom face S4 is 60 degrees, the face angle θ6 between the second side face S5 and the bottom face S4 is 60 degrees, the face angle θ2 between the front face S1 and the first side face S3 is 90 degrees, and the face angle θ3 between the front face S1 and the second side face S5 is 135 degrees.

Because the top face S2 and the bottom face S4 are parallel to each other and the back face S6 is parallel with or perpendicular to the front face S1 for perpendicular output through the back face S6, when at least the six face angles θ1 through θ6 are determined, the rest of the face angles may be determined definitively.

The optical rearrangement device 104 of FIG. 16B corresponds to a case in which the top face S2 and the bottom face S4 are parellelograms. In the optical rearrangement device 104, the input beam BI may be incident in the Z direction through the front face S1 and the output beam BO may be output in the Y direction through the back face S6.

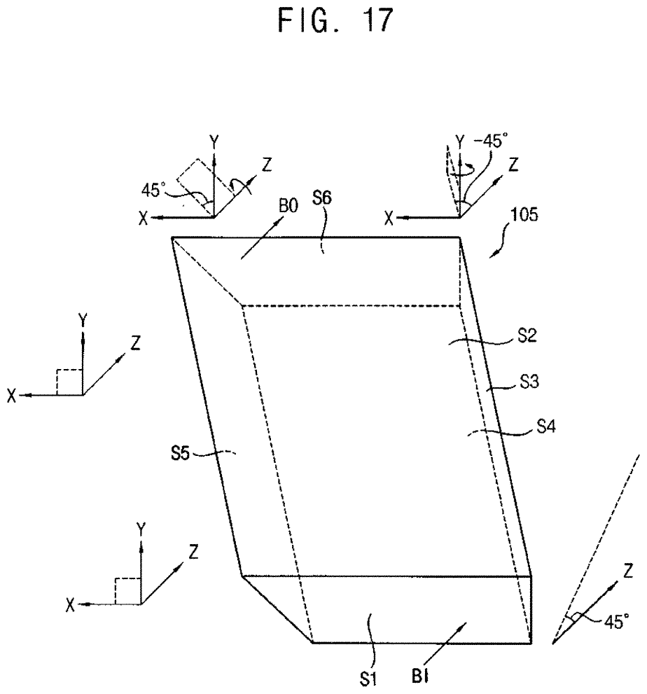

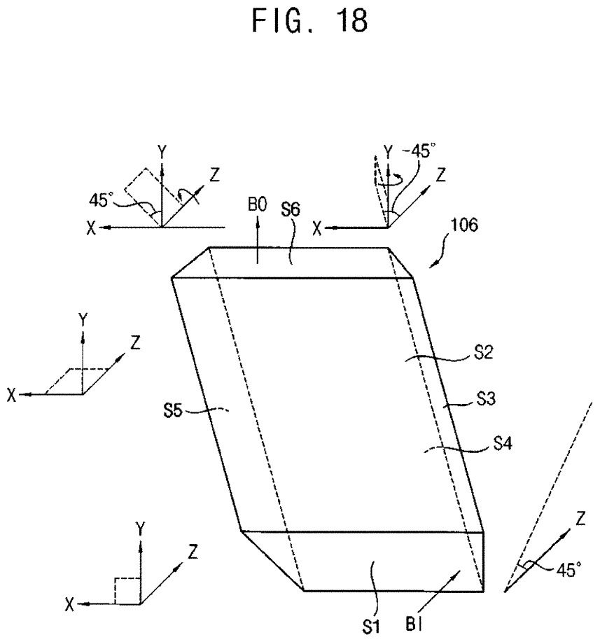

FIGS. 17 and 18 are diagrams illustrating optical rearrangement devices according to exemplary embodiments of the present disclosure.

Referring to FIG. 17, an optical block may be rotated by 45 degrees about the X axis to dispose the optical block in the inclined state, the first side face S3 of an optical rearrangement device 105 may be formed by cutting the optical block in the inclined state in parallel with a plane corresponding to the YZ plane that is rotated by 45 degrees about the Y axis, and the second side face S5 of the optical rearrangement device 105 may be formed by cutting the optical block in the inclined state in parallel with a plane corresponding to the YZ plane that is rotated by 45 degrees about the Z axis.

In addition, the front face S1 of the optical rearrangement device 105 may be formed by cutting the optical block in the inclined state in parallel with the XY plane, and the back face S6 of the optical rearrangement device 105 may be formed by cutting the optical block in the inclined state in parallel with the XY plane.

Obtaining the face angles using the inner product of the normal vectors, as described above with respect to the optical rearrangement device 105 of FIG. 17, the face angle θ1 between the front face S1 and the bottom face S4 is 45 degrees, the face angle θ4 between the back face S6 and the bottom face S4 is 135 degrees, the face angle θ5 between the first side face S3 and the bottom face S4 is 120 degrees, the face angle θ6 between the second side face S5 and the bottom the S4 is 120 degrees, the face angle θ2 between the front face S1 and the first side face S3 is 45 degrees, and the face angle θ3 between the front face S1 and the second side face S5 is 90 degrees.

Because the top face S2 and the bottom face S4 are parallel to each other and the back face S6 is parallel with or perpendicular o the front face S1 for perpendicular output through the back face S6, when at least the six face angles θ1 through θ6 are determined, the rest of the face angles may be determined definitively.

The optical rearrangement device 105 of FIG. 1 corresponds to a case in which the top face S2 and the bottom face S4 are parallelograms. In the optical rearrangement device 105, the input beam BI may be incident in the Z direction through the from face S1 and the output beam BO may be output in the Z direction through the back face S6.

Referring to FIG. 18, an optical block may be rotated by 45 degrees about the X axis to dispose the optical block in the inclined state, the first side face S3 of an optical rearrangement device 106 may be formed by cutting the optical block in the inclined state in parallel with a plane corresponding to the YZ plane that is rotated by −45 degrees about the Y axis, and the second side face S5 of the optical rearrangement device 106 may be formed by cutting the optical block in the inclined state in parallel with a plane corresponding to the YZ plane that is rotated by 45 degrees about the Z axis.

In addition, the front face S1 of the optical rearrangement device 106 may be formed by cutting the optical block in the inclined state in parallel with the XY plane, and the back face S6 of the optical rearrangement device 106 may be farmed by cutting the optical block in the inclined state in parallel with the XZ plane.

Obtaining the face angles with respect to the optical rearrangement device 106 of FIG. 18, the face angle θ1 between the front face S1 and the bottom face S4 is 45 degrees, the face angle θ4 between the back face S6 and the bottom face S4 is 45 degrees, the face angle θ5 between the first side face S3 and the bottom face S4 is 120 degrees, the face angle θ6 between the second side face S5 and the bottom face S4 is 120 degrees, the face angle θ2 between the from face S1 and the first side face S3 is 45 degrees, and the face angle θ3 between the front face S1 and the second side face S5 is 90 degrees.

Because the top face S2 and the bottom face S4 are parallel to each other and the back face S6 is parallel with or perpendicular to the front face S1 for perpendicular output through the back face S6, when at least the six face angles θ1 through θ6 are determined, the rest of the face angles may be determined definitively.

The optical rearrangement device 106 of FIG. 18 corresponds to a case in which the top face S2 and the bottom face S4 are parallelograms. In the optical rearrangement device 105, the input beam BI may be incident in the Z direction through the front face S1 and the output beam BO may be output in the Y direction through the back face S6.

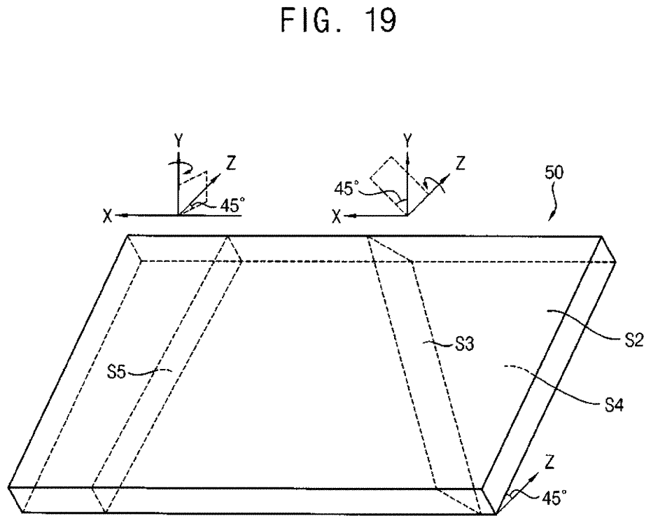

FIGS. 19 through 22 are diagrams illustrating a method of manufacturing an optical rearrangement device according to exemplary embodiments of the present disclosure.

As described above with reference to FIG. 5, the optical block 50 may be rotated by 45 degrees on the X axis to dispose the optical block 50 in an inclined state. The case of the inclined state corresponding to the rotation angle of 45 degrees are described with reference to FIGS. 5, 19 through 23, but the present inventive concept not limited thereto.

In some exemplary embodiments of the present disclosure, the optical rearrangement device may be provided by disposing the optical block 50 in an inclined state corresponding to the rotation angle of −45 degrees and performing the above-described cutting processes.

In some exemplary embodiments of the present disclosure, the optical rearrangement device may be provided by disposing the optical block in a parallel state perpendicular to the Y axis and performing the cutting processes by rotating the above-described cutting planes by −45 degrees with respect to the X axis.

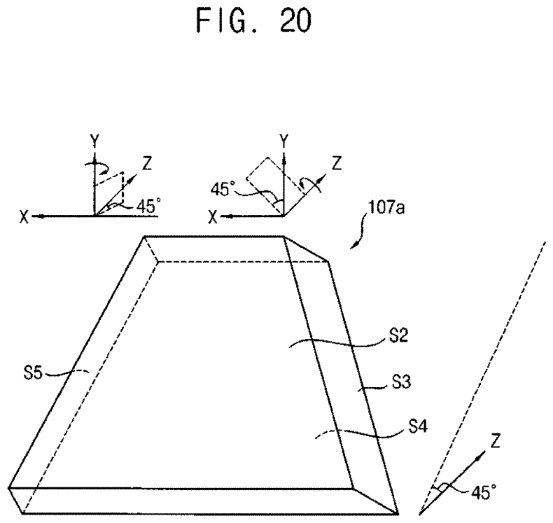

Referring to FIG. 19, the first side face S3 of the optical rearrangement device may be formed by cutting the optical block 50 in the inclined state in parallel with a plane corresponding to the YZ plane that is rotated by 45 degrees with respect to the Z axis, and the second side face S5 of the optical rearrangement device may be formed by cutting the optical block in the inclined state in parallel with a plane corresponding, to the YZ plane that is rotated by 45 degrees with respect to the Y axis. FIG. 20 illustrates an optical block 107a after the cutting processes of FIG. 19 are performed.

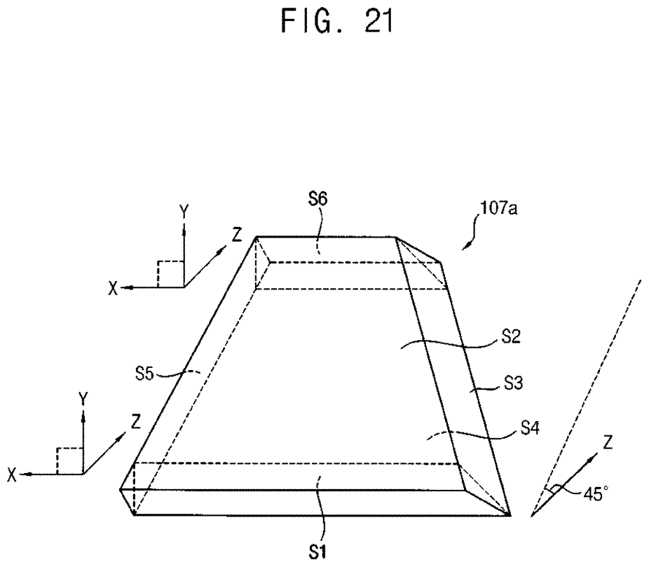

Referring to FIG. 21, the from face S1 of the optical rearrangement device may be formed by cutting the optical block 107a in the inclined state in parallel with the XY plane, and the back face S6 of the optical rearrangement device may be formed by cutting the optical block 107a in the inclined state in parallel with the XY plane. According to exemplary embodiments of the present disclosure, the back face S6 of the optical rearrangement device may be formed by cutting the optical block 107a in the inclined state in parallel with the XZ plane, or the cutting process to form the back face S6 may be omitted.

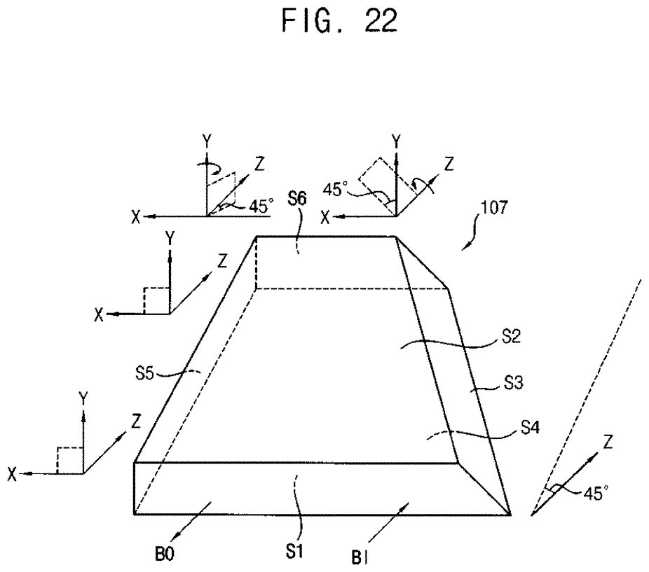

FIG. 22 illustrates a final optical rearrangement device 107 after the cutting processes of FIGS. 19 and 21 are performed.

Obtaining the face angles using the inner product of normal vector as described above with respect to the optical rearrangement device 107, the face angle θ1 between the front face S1 and the bottom face S4 is 45 degrees, the face angle θ4 between the back face S6 and the bottom face S4 is 135 degrees, the thee angle θ5 between the first side face S3 and the bottom face S4 is 60 degrees, the thee angle θ6 between the second side face S5 and the bottom face S4 is 120 degrees, the face angle θ2 between the front face S1 and the first side face S3 is 90 degrees, and the face angle θ3 between the front face S1 and the second side face S5 is 45 degrees.

Because the top face S2 and the bottom face S4 are parallel to each other and the back face S6 is parallel with or perpendicular to the front face S1 for perpendicular output through the back free S6, when at least the six face angles θ1 through θ6 are determined, the rest of the face angles may be determined definitively.

The optical rearrangement device 107 of FIG. 22 corresponds to a case in which the top thee S2 and the bottom face S4 are trapeziums. In comparison with the optical rearrangement device 101 of FIG. 9 in which the totally-reflected beam inside the optical rearrangement device 101 is finally propagated in the Z direction and the output beam BO is output through the back face S6, the totally-reflected beam inside the optical rearrangement device 107 is finally propagated in the Z direction and the output beam 130 is output through the front face S1 in the optical rearrangement device 107 of FIG. 22.

As a result, in the optical rearrangement device 107, the input beam BI may be incident in the Z direction through the front face S1 and the output beam BO may be output in the Z direction through the front face S1. If the input beam BI is incident at a right angle through an end portion of the front face S1, the output beam BO may be output at a right angle through the other end portion of the front face S1.

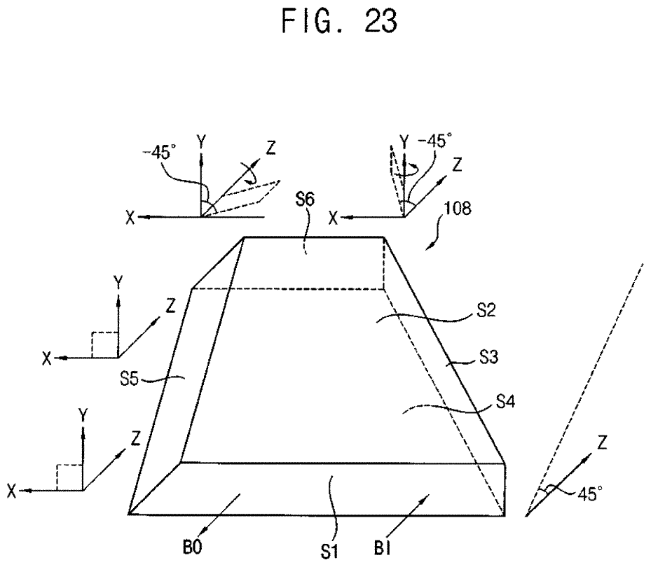

FIG. 23 is a diagram illustrating an optical rearrangement device according to exemplary embodiments of the present disclosure.

Referring to FIG. 23, an optical block may be rotated by 45 degrees with respect to the X axis to dispose the optical block in the inclined state, the first side face S3 of an optical rearrangement device 108 may be formed by cutting the optical block in the inclined state in parallel with a plane corresponding to the YZ plane that is rotated by −45 degrees with respect to the Y axis, and the second side face S5 of the optical rearrangement device 108 may be formed by cutting the optical block in the inclined state in parallel with a plane corresponding to the YZ plane that is rotated by −45 degrees with respect to the Z axis.

In addition, the front face S1 of the optical rearrangement device 108 may be formed by cutting the optical block in the inclined state in parallel with the XY plane, and the back face S6 of the optical rearrangement device 108 may be formed by cutting the optical block in the inclined state in parallel with the XY plane. According to exemplary embodiments of the present disclosure, the back face S6 of the optical rearrangement device 108 may be formed by cutting the optical block in the inclined state in parallel with the XZ plane, or the cutting process to form the back face S6 may be omitted.

Obtaining the face angles using the inner product of the normal vectors as described above with respect to the optical rearrangement device 108 of FIG. 23, the face angle θ1 between the from face S1 and the bottom face S4 is 45 degrees, the face angle θ4 between the back face S6 and the bottom face S4 is 135 degrees, the face angle θ5 between the first side face S3 and the bottom face S4 is 120 degrees, the face angle θ6 between the second side face S5 and the bottom face S4 is 60 degrees, the face angle θ2 between the front face S1 and the first side face S3 is 45 degrees, and the face angle θ3 between the front thee S1 and the second side face S5 is 90 degrees.

Because the top face S2 and the bottom face S4 are parallel to each other and the back face S6 is parallel with or perpendicular to the front face S1 for perpendicular output through the back face S6, when at least the six face angles θ1 through θ6 are determined, the rest of the face angles may be determined definitively.

The optical rearrangement device 108 of FIG. 23 corresponds to a case in which the top face S2 and the bottom face S4 are trapeziums. In comparison with the optical rearrangement device 104 of FIG. 17 in which the totally-reflected beam inside the optical rearrangement device 101 is finally propagated in the Z direction and the output beam 130 is output through the back face S6, the totally-reflected beam inside the optical rearrangement device 108 is finally propagated in the Z direction, and the output beam BO is output through the front face S1 in the optical rearrangement device 108 of FIG. 23.

As a result, in the optical rearrangement device 108, the input beam BI may be incident in the Z direction through the front face S1 and the output beam BO may be output in the Z direction through the front face S1. As described above with reference to FIG. 22, if the input beam BI is incident at a right angle through an end portion of the front face S1, the output beam BO may be output at a right angle through the other end portion of the front face S1.

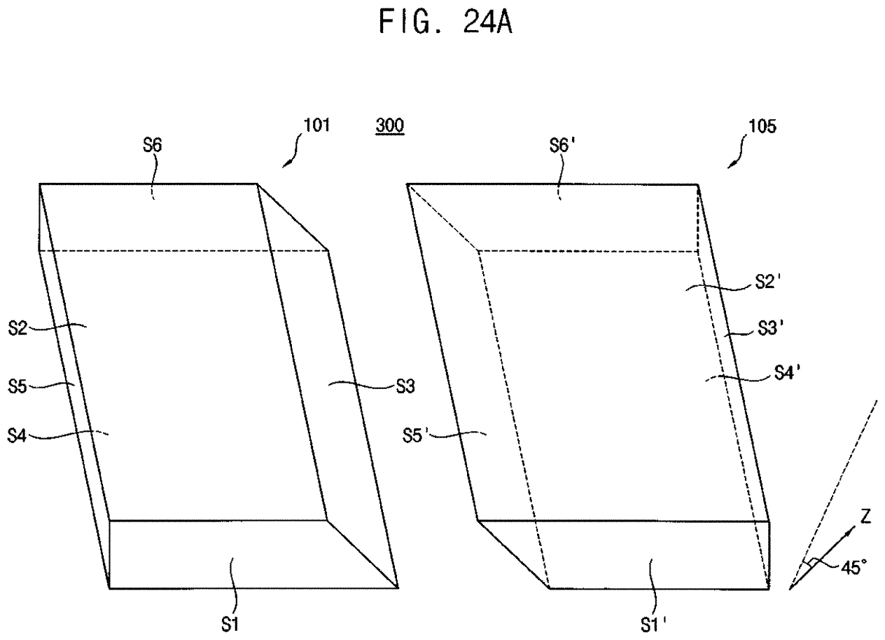

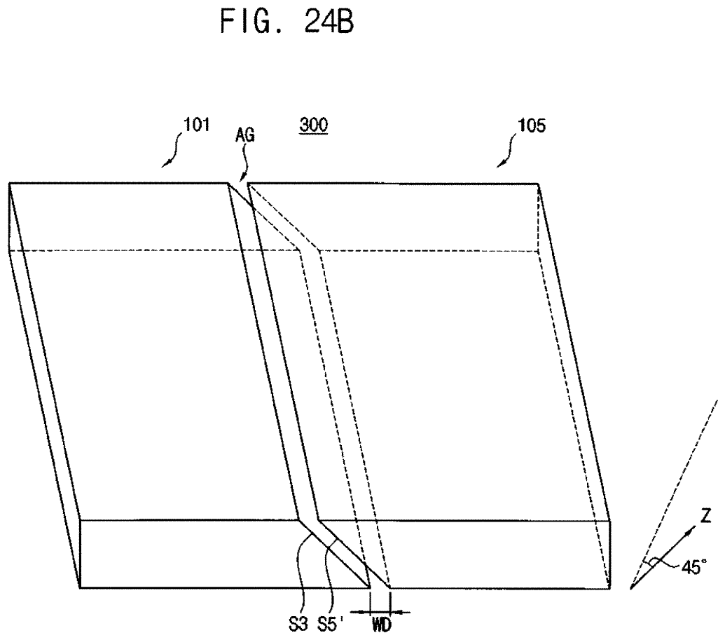

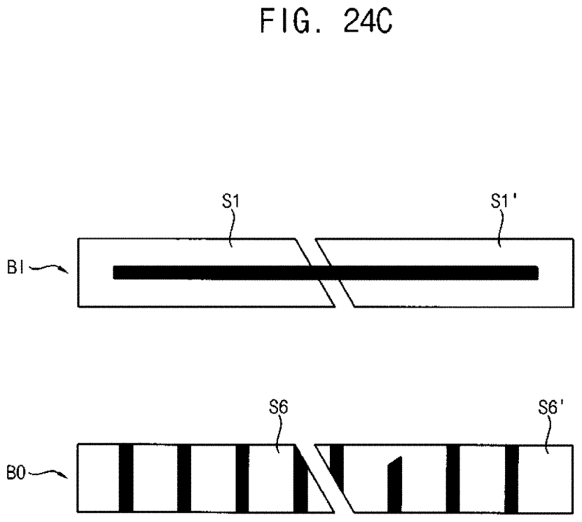

FIGS. 24A, 24B and 24C are diagrams illustrating an optical rearrangement system according to exemplary embodiments of the present disclosure.

FIG. 24A illustrates a state before arranging an optical rearrangement system 300 and FIG. 24B illustrates a state after arranging the optical rearrangement system 300. FIG. 24C illustrates an example of an input beam BI and an output beam BO of the optical rearrangement system 300.

Referring to FIGS. 24A and 24B, the optical rearrangement system 300 may include a plurality of optical rearrangement devices 101 and 105 that are adjacent and arranged in a side direction. For convenience of illustration, FIGS. 24A and 24B illustrate only two optical rearrangement devices, e.g., a left optical rearrangement device 101 and a right optical rearrangement device 105. In the same way, an optical rearrangement system may include three or more optical rearrangement devices arranged in the side direction. The entire size of the optical rearrangement system may be reduced by arranging two or more optical rearrangement devices in comparison with the optical rearrangement system of one large optical rearrangement device.

According to exemplary embodiments of the present disclosure, each of the optical rearrangement devices 101 and 105 includes an optical block of a hexahedral shape having a front face, a top face, a first side face, a bottom face, a second side face and a back face. The top face is parallel with the bottom face, and the front face, the top face, the first side face, the bottom face, the second side face and the back face form face angles such that, when an input beam is incident through the front face at a right angle, the input beam is totally reflected at the top face, the bottom face, the first side face and the second side face and an output beam is output through the front face or the back face at a right angle.

As described herein with reference to FIGS. 4 through 9, an optical block may be rotated by 45 degrees with respect to the X axis to dispose the optical block 50 in an inclined state, the first side face S3 of the left optical rearrangement device 101 may be formed by cutting the optical block in the inclined state in parallel with a plane corresponding to the YZ plane that is rotated by 45 degrees with respect to the Z axis, and the second side face S5 of the left optical rearrangement device 101 may be formed by cutting the optical block in the inclined state in parallel with a plane corresponding to the YZ plane that is rotated by 45 degrees with respect to the axis.

In addition, the front face S1 of the left optical rearrangement device 101 may be farmed by cutting the optical block in the inclined state in parallel with the XY plane, and the back face S6 of the left optical rearrangement device 101 may be formed by cutting the optical block in the inclined state in parallel with the XY plane. The top face S2 and the bottom face S4 of the left optical rearrangement device 101 are parallel.

As described with reference to FIG. 9, with respect to the left optical rearrangement device 101, the face angle θ1 between the front face S1 and the bottom face S4 is 45 degrees, the face angle θ4 between the back face S6 and the bottom face S4 is 135 degrees, the face angle θ5 between the first side face S3 and the bottom face S4 is 60 degrees, the face angle θ6 between the second side face S5 and the bottom face S4 is 60 degrees, the face angle θ2 between the front face S1 and the first side face S3 is 90 degrees, and the face angle θ3 between the front face S1 and the second side face S5 is 135 degrees.

As described with reference to FIG. 17, an optical block may be rotated by 45 degrees with respect to the X axis to dispose the optical block in the inclined state, the first side face S3′ of the right optical rearrangement device 105 may be formed by cutting the optical block in the inclined state in parallel with a plane corresponding to the YZ plane that is rotated by 45 degrees with respect to the Y axis, and the second side face S5′ of the right optical rearrangement device 105 may be formed by cutting the optical block in the inclined state in parallel with a plane corresponding to the YZ plane that is rotated by 45 degrees with respect to the Z axis.

In addition, the front face S1′ of the right optical rearrangement device 105 may be formed by cutting the optical block in the inclined state in parallel with the XY plane, and the back face S6′ of the right optical rearrangement device 105 may be formed by cutting the optical block in the inclined state in parallel with the XY plane. The top face S2′ and the bottom face S4′ of the right optical rearrangement device 105 are parallel.

As described herein with reference to FIG. 17, with respect to the right optical rearrangement device 105, the face angle θ1 between, the front face S1 and the bottom face S4′ is 45 degrees, the face angle θ4 between the back face S6′ and the bottom face S4′ is 135 degrees, the face angle θ5 between the first side face S3′ and the bottom face S4′ is 120 degrees, the face angle θ6 between the second side face S5′ and the bottom face S4′ is 120 degrees, the face angle θ2 between the front face S1 and the first side face S3′ is 45 degrees, and the face angle θ3 between the front face S1′ and the second side face S5′ is 90 degrees.

As a result, the right side face S3 of the left optical rearrangement device 101 may be arranged to be parallel with the right side face S5′ of the right optical rearrangement device 105 so that an airgap AG between the left optical rearrangement device 101 and the right optical rearrangement device 105 may have a constant width WD.

Referring to FIG. 24C, the input beam BI may have a line shape extending in the front face S1 of the left optical rearrangement device 101 and the front face S1′ of the right optical rearrangement device 105. In this case, a first set of the sliced beams of the output beam BO may be output through the back face S6 of the left optical rearrangement device 101 and a second set of the slice beams of the output beam BO may be output through the back face S6′ of the right optical rearrangement device 105.

The portion of the input beam BI incident on the airgap AG corresponds to the loss of light. The width WD of the airgap AG may be set to be as small as possible so the loss of light by the airgap AG may be minimized.

When the positions of the left optical rearrangement device 101 and the right optical rearrangement device 105 are interchanged, the same output beam BO may be obtained.

Exemplary embodiments of the present inventive concept may be applied to a mirror tunnel. The mirror tunnel may have a tunnel shape surrounded by four mirrors corresponding to the top face S2, the first side face S3, the bottom face S4 and the second side face S5 of the above-described optical rearrangement device. The front portion and the back portion of the mirror tunnel are open.

The mirror faces of the mirror tunnel may form face angles such that, when an input beam is incident through the open front portion with an incidence angle of 45 degrees to the mirror face corresponding to the bottom face S4, the input beam may be totally reflected at the four mirror faces and an output beam may be output through the open back portion. Reflection coating layers may be formed on the four mirror faces, for example, the inner surfaces of the four mirrors.

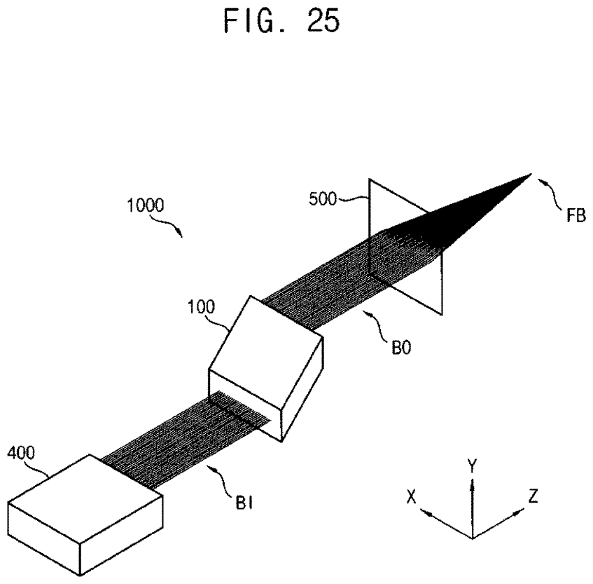

FIG. 25 is a diagram illustrating a beam thrilling system according to exemplary embodiments of the present disclosure.

Referring to FIG. 25, a beam forming system 1000 may include an input beam generator 400, an optical rearrangement device 100 and a focusing lens unit 500.

The input beam generator 400 may generate an input beam BI having a line shape extending in the X direction or including a plurality of lights arranged in the X direction.

In some exemplary embodiments of the present disclosure, the input beam generator 400 may include a beam expander, which may extend a beam radiated in the Z direction from a light source to provide an elliptical beam of a continuous pattern extending in the X direction. The beam expander may be implemented as one or more of a convex lens, a concave lens, a cylindrical lens, a beam resampling unit, and so on.

In some exemplary embodiments of the present disclosure, the input beam generator 400 may include a laser diode array configured to radiate a plurality of laser beams in the Z direction. The laser diode array may include a plurality of laser diodes arranged in the X direction, and the plurality of laser beams of a sliced pattern may be arranged in the X direction.

The optical rearrangement device 100, according to exemplary embodiments of the present disclosure, may receive the input beam BI of the continuous pattern or the sliced pattern and perform the division of the input beam BI and the reversing of the angle distributions as described above.

The optical rearrangement device 100 includes an optical block of a hexahedral shape having a front face, a top face, a first side face, a bottom face, a second side face and a back face. The top face may be parallel with the bottom face. The front face, the top face, the first side face, the bottom face, the second side face and the back face may form face angles such that, when the input beam BI is incident through the front face at a right angle, the input beam is totally reflected at the top face, the bottom face, the first side face and the second side face and an output beam is output through the front face or the back face at a right angle.

As such, the optical rearrangement device 100, according to exemplary embodiments of the present disclosure, may reduce loss of light of a beam using only vertical incidence, vertical penetration and total reflection.

In addition, the optical rearrangement device 100 may divide the input beam BI propagating in the Z direction into a plurality of portions, reverse a first axis in an X direction and a second axis in a Y direction with respect to each of the plurality of portions and provide the output beam including a plurality of sliced beams that are arranged in the X direction. As such, the optical rearrangement device 100, according to exemplary embodiments of the present disclosure, may efficiently implement the division of the input beam and the reversing of the angle distributions using one optical block.

Further, the optical rearrangement device 100 may be manufactured easily through cutting of one optical block and arranged conveniently with other optical devices such as the input beam generator 400 and the focusing lens unit 500 when forming an optical system such as the beam forming system 1000.

The focusing lens unit 500 may focus the plurality of the sliced beams of the output beam BO to generate a final beam FB of a line shape or a spot shape. The focusing lens unit 500 may be implemented as a various combination of at least one of a convex, lens, a concave lens, a cylindrical lens, a homogenization unit, and so on.

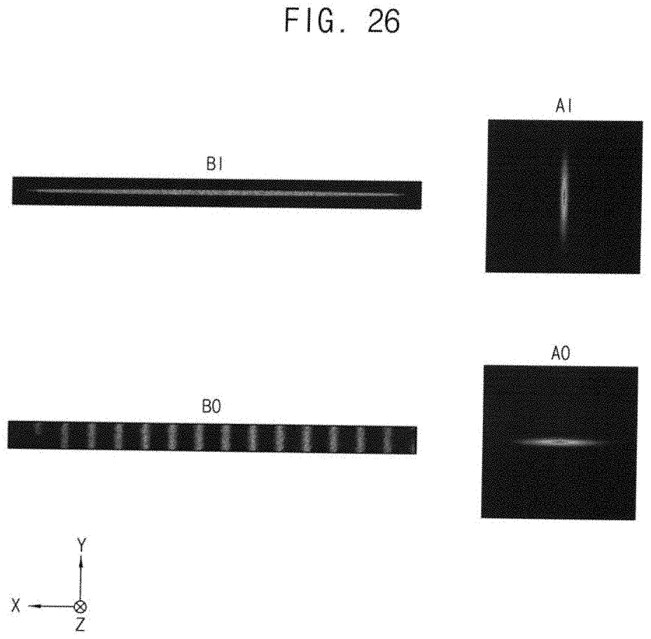

FIGS. 26 through 28 are diagrams illustrating beam forming processes by the beam forming system of FIG. 25.

FIG. 26 illustrates an input beam BI extending in the X direction, an output beam BO and corresponding angle distributions AI and AO, which may be generated, for example, by a beam expander.

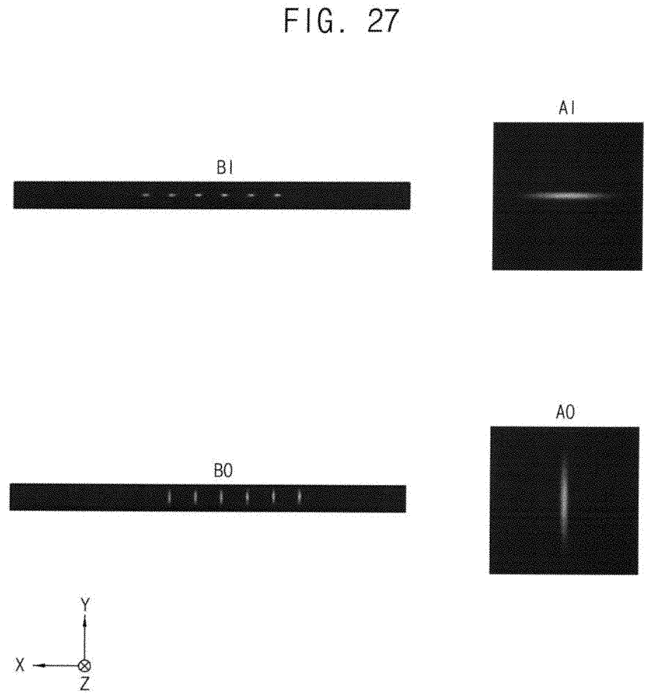

FIG. 27 illustrates an input beam BI including a plurality of lights arranged in the X direction, an output beam BO and corresponding angle distributions AI and AO, which may be generated, for example, by a laser diode array.

As illustrated in FIGS. 26 and 27, the optical rearrangement device 100, according to exemplary embodiments of the present disclosure, may implement, efficiently and simultaneously, the reversing of the angle distributions in the X direction and the Y direction its addition to the division of the input beam BI to provide the output beam BO.

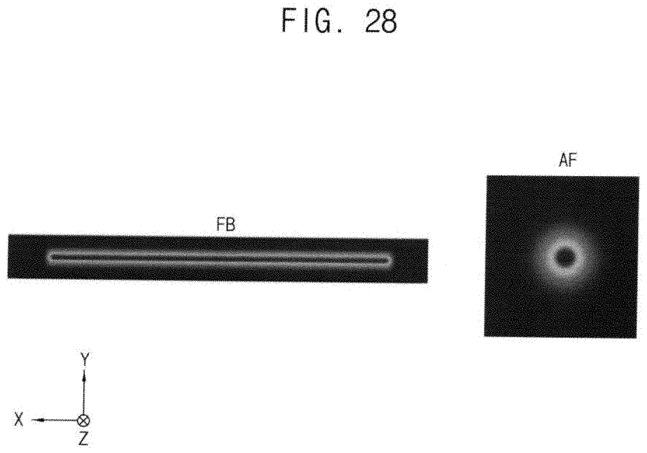

FIG. 28 illustrates an example of a final beam FB generated by the focusing lens unit 500. FIG. 28 illustrates a non-limiting final beam FB of a shape of a line beam and the corresponding angle distributions AF. In some exemplary embodiments of the present disclosure, the focusing lens unit may be implemented to provide a final beam of a spot shape.

To maximize beam focusing, the angle distributions may be small. When the angle distribution in the focusing direction is large and the angle distribution in the direction perpendicular to the focusing direction is small, the angle distributions may be reversed for effective focusing.

For example, a plurality of laser beams from a laser diode array may be focused to provide an output beam of high power. When the direction of the array is large and the angle distribution in the direction perpendicular to the array is small, the angle distributions may be efficiently reversed using the optical rearrangement device 100 according to exemplary embodiments of the present disclosure.

As described above, the optical rearrangement device, according to exemplary embodiments of the present disclosure, may reduce loss of light of a beam using vertical incidence, vertical penetration and total reflection. In addition, the optical rearrangement device, according to exemplary embodiments of the present disclosure, may efficiently implement the division of the input beam and the reversing of the angle distributions using one optical block. Further, the optical rearrangement device, according to exemplary embodiments of the present disclosure, may be manufactured easily through cutting of one optical block and arranged conveniently with other optical devices when forming an optical system such as a beam forming system.

The present inventive concept may be applied to any optical devices and systems requiring the reversing of the angle distributions. For example, the present inventive concept may be applied to semiconductor manufacturing processes and test devices for semiconductor devices.

The foregoing is illustrative of exemplary embodiments of the present disclosure and is not to be construed as limiting thereof. Although a few exemplary embodiments of the present disclosure have been described, those skilled in the art will readily appreciate that many modifications are possible without materially departing from the present inventive concept.

1. An optical rearrangement device, comprising:
an optical block having a substantially hexahedral shape, the optical block including a front face, a top face, a first side face, a bottom face, a second side face, and a back face,
wherein the top face is parallel with the bottom face, and
wherein the optical block is arranged such that when an input beam is incident through the front face at a right angle thereto, the input beam is totally reflected at each of the top face, the bottom face, the first side face, and the second side face and an output beam is output through the front face or the back face at a right angle thereto.

2. The optical rearrangement device of claim 1, wherein the optical rearrangement device is configured to:
divide the input beam propagating in a Z direction into a plurality of portions;
reverse a distribution of the input beam about a first axis in an X direction and about a second axis in a Y direction, with respect to each of the plurality of portions; and
provide the output beam, including a plurality of sliced beams that are arranged in the X direction.

3. The optical rearrangement device of claim 1, wherein a number and a width of the plurality of sliced beams are dependent upon a thickness between the top face and the bottom face.

4. The optical rearrangement device of claim 1, wherein the optical block is configured such that a beam propagating inside the optical rearrangement device is totally reflected at each of the top face, the bottom face, the first side face, and the second side face with an incidence angle of 45 degrees and a reflection angle of 45 degrees.

5. The optical rearrangement device of claim 1, wherein the optical block is configured such that a face angle between the front face and the bottom face is 45 degrees or 135 degrees, a face angle between the back face and the bottom face is 45 degrees or 135 degrees, a face angle between the first side face and the bottom face is 60 degrees or 120 degrees, and a face angle between the second side face and the bottom face is 60 degrees or 120 degrees.

6. The optical rearrangement device of claim 5, wherein the optical block is configured such that a face angle between the front face and the first side face is 90 degrees, and a face angle between the front face and the second side face is 45 degrees or 135 degrees.

7. The optical rearrangement device of claim 1, wherein the optical block is configured such that a face angle between the front face and the bottom face is 45 degrees, a face angle between the back face and the bottom face is 45 degrees or 135 degrees, a face angle between the first side face and the bottom face is 60 degrees, a face angle between the second side face and the bottom face is 60 degrees, a face angle between the front face and the first side face is 90 degrees, and a face angle between the front face and the second side face is 135 degrees.

8. The optical rearrangement device of claim 7, wherein, the optical block is configured such that when the input beam is incident through the front face at a right angle thereto, the output beam is output through the back face at a right angle thereto.

9. The optical rearrangement device of claim 7, wherein each of the top face and the bottom face is substantially parallelogram shaped.

10. The optical rearrangement device of claim 1, wherein the optical block is configured such that a face angle between the front face and the bottom face is 45 degrees, a face angle between the hack face and the bottom face is 45 degrees or 135 degrees, a face angle between the first side face and the bottom face is 60 degrees, a face angle between the second side face and the bottom face is 120 degrees, a face angle between the front face and the first side face is 90 degrees, and a face angle between the front face and the second side face is 45 degrees.

11. The optical rearrangement device of claim 10, wherein, the optical block is configured such that when the input beam is incident through the front face at a right angle thereto, the output beam is output through the front face at a right angle thereto.

12. The optical rearrangement device of claim 10, wherein the optical block is configured such that the top face and the bottom face are each substantially trapezium shaped.

13. The optical rearrangement device of claim 1, further comprising:
an anti-reflection coating layer formed on the front face or the back face.

14. The optical rearrangement device of claim 1, wherein the optical block is configured such that the face angles between the front face, the top face, the first side face, the bottom face, the second side face, and the back face are formed by cutting an original optical block three or four times.

15. An optical rearrangement device, comprising:
an optical block having a hexahedral shape, the optical block including a front face, a top face, a first side face, a bottom face, a second side face, and a back face,
wherein the top face is parallel with the bottom face, and
wherein the optical block is arranged such that a face angle between the front face and the bottom face is 45 degrees or 135 degrees, a face angle between the back face and the bottom face is 45 degrees or 135 degrees, a face angle between the first side face and the bottom face is 60 degrees or 120 degrees, a face angle between the second side face and the bottom face is 60 degrees or 120 degrees, a face angle between the front face and the first side face is 90 degrees, and a face angle between the front face and the second side face is 45 degrees or 135 degrees.

16. The optical rearrangement device of claim 15, wherein, the optical block is arranged such that when an input beam is incident through the front face at a right angle thereto, an output beam is output through the front face or the back face at a right angle thereto.

17. The optical rearrangement device of claim 15, wherein the optical rearrangement device is configured to:
divide an input beam propagating in a Z direction into a plurality of portions;
reverse a distribution of the input beam about a first axis in an X direction and about a second axis in a Y direction, with respect to each of the plurality of portions; and
provide the output beam, including a plurality of sliced beams that are arranged in the X direction.

18-19. (canceled)

20. A beam forming system, comprising:
an optical rearrangement device comprising an optical block having a substantially hexahedral shape, the optical block including a front face, a top face, a first side face, a bottom face, a second side face, and a back face, wherein the optical block is arranged such that, when an input beam is incident through the front face at a right angle thereto, the input beam is totally reflected at each of the top face, the bottom face, the first side face, and the second side face and an output beam is output through the front face or the back face at a right angle thereto; and
a focusing lens unit configured to focus the output beam to generate a final beam of a line shape or a spot shape.

21. The beam forming system of claim 20, wherein the optical rearrangement device is configure to:
divide the input beam propagating in a Z direction into a plurality of portions;
reverse a distribution of the input beam about a first axis in an X direction and about a second axis in a Y direction, with respect to each of the plurality of portions; and
provide the output beam, including a plurality of sliced beams that are arranged in the X direction.

22. The beam forming system of claim 20, wherein the focusing lens unit is configured to focus the plurality of sliced beams of the output beam in the X direction to generate the final beam.

23-27. (canceled)
